(19) United States
(12) Patent Application Publication
(10) Pub. No.: US 2016/0372822 A1
(43) Pub. Date: Dec. 22, 2016

(54) SEGMENTED STRUCTURE, IN PARTICULAR FOR A SATELLITE ANTENNA REFLECTOR, PROVIDED WITH AT LEAST ONE DEPLOYMENT DEVICE WITH A PARALLELOGRAM

(71) Applicant: Christophe Mayeux, Mareil Marly (FR)

(72) Inventor: Christophe Mayeux, Mareil Marly (FR)

(73) Assignee: Airbus Defence and Space SAS, Les Mureaux (FR)

(21) Appl. No.: 15/102,504

(22) PCT Filed: Dec. 10, 2014
(86) PCT No.: PCT/FR2014/000266

§ 371 Date: Jun. 7, 2016

(30) Foreign Application Priority Data
Dec. 17, 2013 (FR) 13/02970

(51) Int. Cl. H01Q 1/28; H01Q 15/16

(52) U.S. Cl. CPC H01Q 1/288; H01Q 15/162

(57) ABSTRACT

A segmented structure includes at least two panels, one panel referred to as a main panel and at least one panel referred to as a secondary panel. The structure further includes at least one unfurling device configured to bring a secondary panel into a storage position or into an unfurled position. The unfurling device has at least one strip fixed to the secondary panel and connected to the main panel. The strip is elastically preloaded into the storage position thereof so as to unfurl automatically and autonomously when relative movement between the secondary panel and the main panel becomes possible, so as to move the secondary panel.

The present invention relates to a segmented structure.

This segmented structure comprises at least two panels connected together and intended for deployment in space.

Although not exclusively, the present invention applies more particularly to a segmented structure forming part of a telecommunication satellite antenna reflector, in particular to a large antenna reflector, functioning in high frequency bands. The size of the reflector is inversely proportional to the frequency (at constant gain). Such an antenna reflector generally comprises a rigid structure (referred to as the shell) provided with a reflective surface and reinforcement means at the rear of this surface, which participate in the holding of the shell and in the connection to the satellite.

The large size of the shell of such a reflector poses problems of space requirement when a satellite provided with such a reflector is sent into space by means of a space launcher.

Thus, for rigid reflectors having diameters of several metres, a segmented structure is provided, provided with a plurality of panels, in particular a structure with three panels comprising a middle panel and two end panels.

This segmented structure also comprises a deployment device for each end panel, which is suitable for bringing the end panel, relative to the main panel:
either into a storage position, in which the end panel is superimposed on the main panel on the rear face of said main panel, the front face of the end panel being directed in the same direction as the front face of the main panel;
or in a deployed position, in which the end panel is positioned alongside and against the main panel so as to form a continuous assembly at least on the front faces thereof.

In such a segmented structure, each end panel can therefore adopt a storage position for transport in the space launcher and a deployed position when the satellite is in space.

The present invention relates to a segmented structure, in particular for a satellite antenna reflector, comprising at least two panels and a deployment device making it possible to carry out in space effective and advantageous deployment of these two panels.

According to the invention, said segmented structure of the type comprising:
at least two panels, a first so-called main panel comprising a front face and a rear face, and a second so-called secondary panel also comprising a front face and a rear face; and
at least one deployment device connected to the rear faces respectively of said main and secondary panels and suitable for bringing said secondary panel into one or other of the following two positions, relative to said main panel:
   a storage position, in which said secondary panel is at least partly superimposed on said main panel on the rear face thereof, the front face of said secondary panel being directed in the same direction as the front face of said main panel; and
   a deployed position, in which said secondary panel is positioned towards the outside of the main panel, alongside and against said main panel so as to form a continuous assembly at least on the front faces thereof,
      is remarkable in that said deployment device comprises:
a system with a parallelogram comprising at least two linking arms arranged substantially parallel, so as to form a parallelogram, each of said linking arms being linked by a first of the ends thereof, via a first hinge comprising at least a first spring, to the rear face of said secondary panel, and by a second of the ends thereof, via a second hinge comprising at least a second spring, to the rear face of said main panel, said first and second springs being capable, after prestressing, of moving said secondary panel with respect to said main panel in a circular translation movement from the storage position to an intermediate position; and
auxiliary guiding means configured so as to implement end guidance from said intermediate position to the deployed position.

Thus, by virtue of the invention, the secondary panel of the segmented structure may be deployed effectively and advantageously in space, from the storage position to the deployed position, as specified below.

Moreover, in a preferred embodiment, the deployment device also comprises at least one dry-friction damper, fixed by means of auxiliary hinges, respectively, by a first of the ends thereof to the rear face of the secondary panel and by a second of the ends thereof to the rear face of the main panel.

Said first and second springs may have various features, in particular, advantageously:
at least one of said first and second springs is made of one of the following materials: a metal material, a composite material, and a ceramic material;
at least one of said first and second springs corresponds to one of the following types of spring: a leaf spring or a torsional spring;
at least one of said first and second springs is provided with a surface treatment; and/or
at least one of said first and second springs is provided with a flexible thermal shield.

Moreover, advantageously, at least one of said first and second hinges comprises at least one resilient element producing flexibility in a plane substantially parallel to the mid-plane of the main panel. In addition, advantageously, the axes of rotation of the first and second hinges of each of the linking arms of the parallelogram system are suited to geometric characteristics of the segmented structure so that the secondary panel follows the profile of the main panel during movement. Furthermore, preferably, said first hinges of the linking arms of the parallelogram system are arranged substantially at the centre of gravity of the secondary panel.

Moreover, in a first embodiment, said auxiliary guiding means comprise:
at least one cable that is connected by one of the ends thereof to the secondary panel and by the other of the ends thereof to the main panel, at the respective contact faces, and
at least one reel device suitable for reeling said cable in order to bring said secondary panel towards said main panel.

Furthermore, in a second embodiment, said auxiliary guiding means comprise at least two guide rails arranged on the rear face of the main panel so as to allow the secondary panel to slide on said guide rails, said guide rails being configured so as to guide the secondary panel to the deployed position, during the end guidance, and the parallelogram system (also forming part of the auxiliary guiding means) is configured so as to press said secondary panel on said guide rails and to move said panel in order to implement the end guidance.

Moreover, in a preferred embodiment, the segmented structure comprises:
a middle main panel;
two secondary panels arranged on either side of said middle main panel in the deployed position so as to have a parabolic shape; and
two deployment devices associated respectively with said secondary panels.

The present invention also relates to:
a satellite antenna reflector that comprises a segmented structure as aforementioned, and
a satellite that comprises at least one such segmented structure or one such antenna reflector.

The present invention also relates to a method for deploying a segmented structure as aforementioned.

According to the invention, this method comprises successive steps consisting, during deployment from the storage position to the deployed position, of:
a) performing a circular translation movement of the secondary panel with respect to the main panel as far as said intermediate position, by means of the parallelogram system; and
b) implementing the end control from the intermediate position to the deployed position, using the auxiliary guiding means.

In a first variant, step b) consists of moving said secondary panel towards said main panel by reeling at least one cable connected by one of the ends thereof to the secondary panel and by the other of the ends thereof to the main panel, at respective contact faces, by means of at least one reel device.

Furthermore, in a second variant, step b) consists of pressing and sliding the secondary panel on at least two guide rails arranged on the rear face of the main panel, as far as the deployed position, by means of said parallelogram system.

The figures of the accompanying drawings will give a clear understanding of how the invention can be implemented. In these figures, identical references designate similar elements.

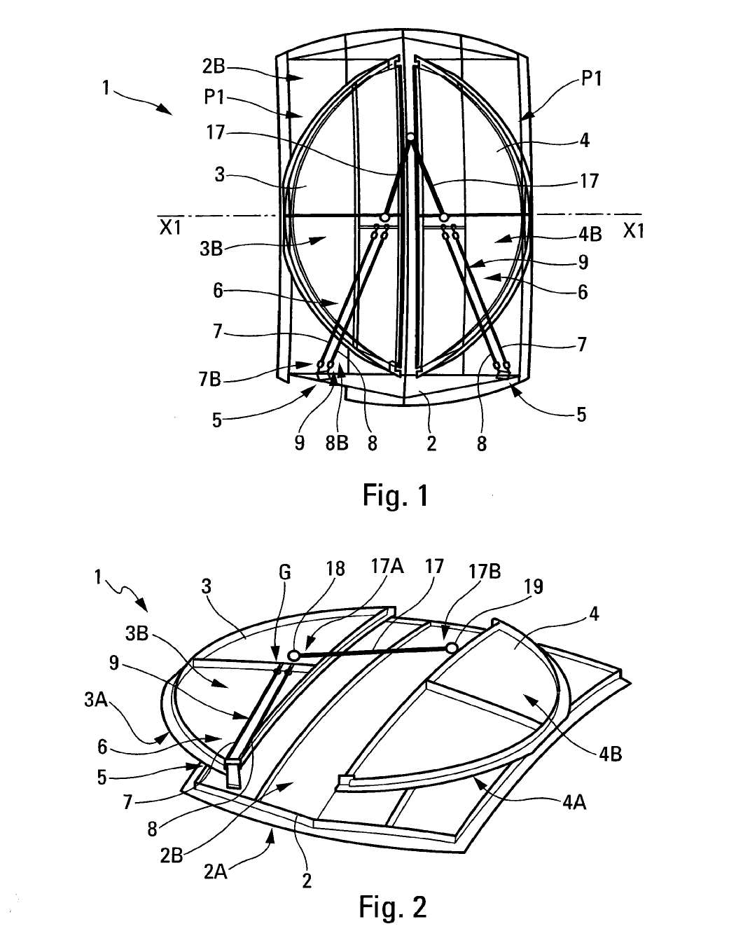

FIG. 1 is a schematic plan view of a particular embodiment of a segmented structure illustrating the invention and comprising a middle main panel, as well as two secondary panels, in the storage position.

FIG. 2 shows, schematically in perspective, a segmented structure in a situation of deployment of a secondary panel.

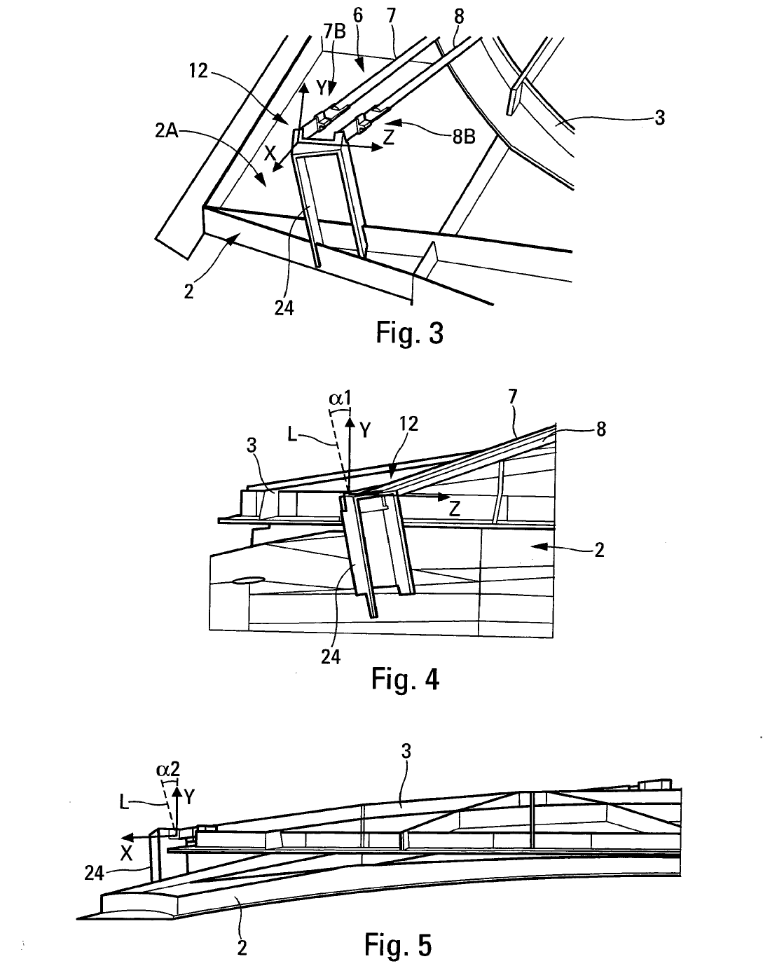

FIGS. 3 to 5 are various schematic views showing the arrangement of hinge axes of rotation.

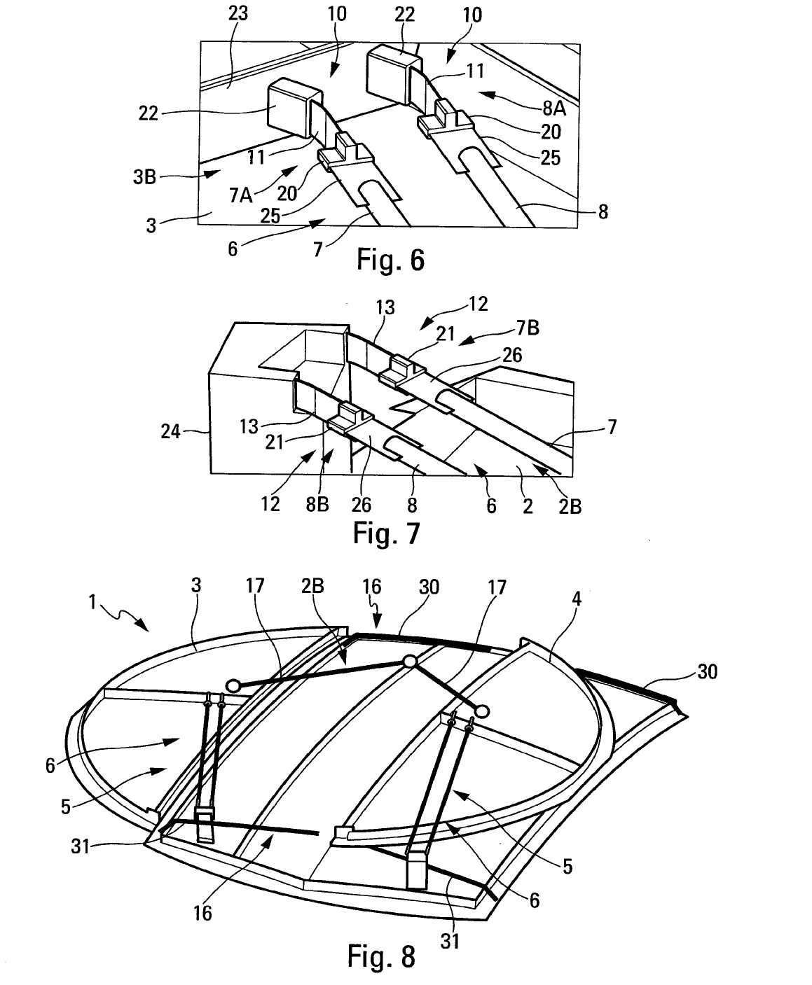

FIGS. 6 and 7 illustrate schematically, in perspective, embodiments of hinges of a parallelogram system.

FIG. 8 shows a particular example of auxiliary guiding means.

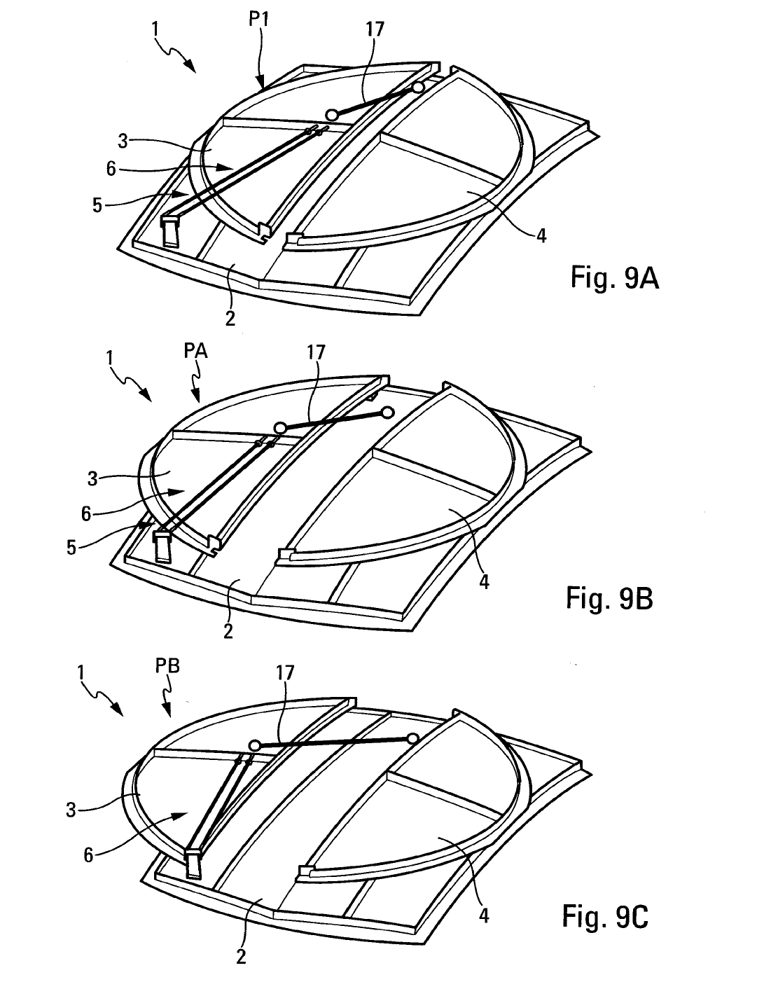

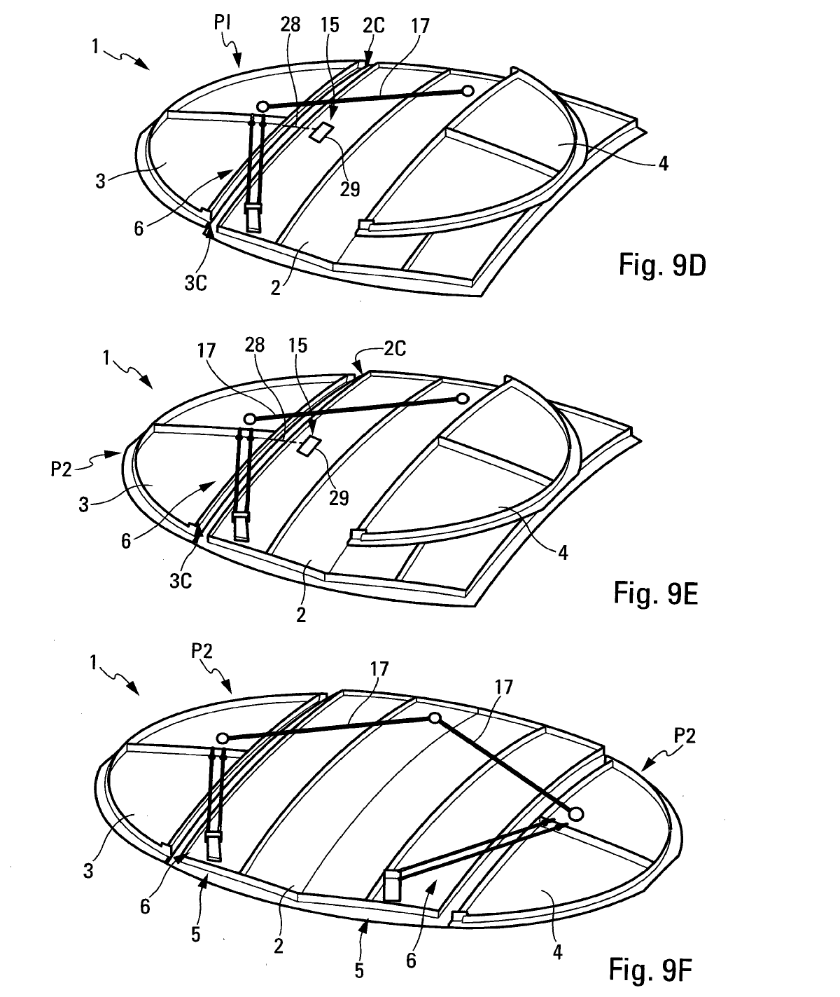

FIG. 9A to 9F illustrate, in schematic perspective view, various successive steps of deploying secondary panels with respect to a main panel of a segmented structure.

The segmented structure 1, illustrating the invention and depicted schematically in FIG. 1 in particular, is intended, more particularly but not exclusively, for a telecommunication satellite antenna reflector. Such an antenna reflector generally comprises, when it is deployed in space, a rigid structure (referred to as the shell) provided with a reflective surface, as well as reinforcing and holding means (not shown) at the rear of this structure, which participate in the holding of the shell and in the connection to the satellite. In particular for reasons of space requirement when the satellite is launched by a space launcher, this structure is of the segmented type, that is to say it is formed by a plurality of segments or panels.

More precisely, the present invention relates to a segmented structure 1 of the type comprising:
at least two panels, namely at least a first so-called main panel 2 comprising a front face 2A and a rear face 2B (FIGS. 1 and 2), and at least a second so-called secondary panel 3, 4 also comprising a front face 3A, 4A and a rear face 3B, 4B; and
at least one deployment device 5 that is connected to the rear faces 2B and 3B respectively of the main panel 2 and of a secondary panel 3, 4 (the deployment device 5 intended for the panel 4 not being shown in the example in FIG. 2).

This deployment device 5 is suitable for bringing the associated secondary panel, for example the secondary panel 3, into one or other of the following two positions, relative to the main panel 2:
a storage position P1, as depicted in FIGS. 1 and 9A, in which said secondary panel 3 is at least partly superimposed and preferably completely superimposed on the main panel 2 on the rear face 2B thereof. The front face 3A of the secondary panel 3 is directed in the same direction as the front face 2A of the main panel 2; and
a deployed position P2, as depicted in FIGS. 9E and 9F, in which the secondary panel 3 is positioned alongside and against the main panel 2 so as to form a continuous assembly at least on the front faces thereof 2A and 3A.

In the description of the present invention:
front face and rear face mean the two faces of a panel, the front face 3A, 4A of a secondary panel 3, 4 being at least partly superimposed on the rear face 2B of the main panel 2, each front face 2A, 3A, 4A corresponding in the case of an antenna reflector to the reflective face; and
internal, inside, inward, etc. and external, outside, outward, etc. mean the positions of the various elements concerned with respect to the centre of the segmented structure 1 in the deployed position thereof (FIG. 9F), “internal, inside, inward, etc.” applying to the position closest to the centre and “external, outside, outward, etc.” applying to the position furthest away from the centre in this deployed position (in the direction of an axis X1-X1 (FIG. 1), in this case an axis of symmetry of the segmented structure 1).

In the preferred embodiment, depicted in the figures, the segmented structure 1 comprises:
a middle main panel 2;
two secondary panels 3 and 4 arranged on either side of said middle main panel 2 in the completely deployed position (FIG. 9F) so that these three panels 2, 3 and 4 have a parabolic form in this completely deployed position; and
two deployment devices 5 associated respectively with said secondary panels 3 and 4, of which only the one associated with the secondary panel 3 is depicted in FIG. 2 and FIG. 9A to 9E.

In the situation in FIG. 1, the two secondary panels 3 and 4 are in the storage position P1.

According to the invention, each of the deployment devices 5 of the segmented structure 1 comprises:
a parallelogram system 6 comprising at least two linking arms 7 and 8 arranged substantially parallel, so as to form a parallelogram 9. Each of said linking arms 7 and 8 is connected by a first 7A, 8A of the ends thereof, via a hinge 10 comprising at least one spring 11, to the rear face 3B, 4B of the secondary panel 3, 4 (FIG. 6), and by a second 7B, 8B of the ends thereof, via a hinge 12 comprising at least one spring 13, to the rear face 2B of the main panel 2 (FIG. 7). The springs 11 and 13 are, after prestressing, suitable for moving the secondary panel 3, 4 with respect to the main panel 2, from inside to outside, in a circular translation movement from the storage position P1 to a non-superimposed intermediate position PI (that is to say in which the secondary panel 3, 4 and the main panel 2 are no longer superimposed or only over a small area); and
auxiliary guiding means 15, 16 configured so as to implement end guidance from said intermediate position PI to the deployed position P2.

Such a deployment device 5 makes it possible to perform an effective and advantageous deployment of the secondary panel 3, 4, with which it is associated, from the storage position P1 to the deployed position P2, as specified below.

The deployment is then effected by a parallelogram system 6 fixed on the one hand to a peripheral zone of the rear face 2B of the middle main panel 2 and on the other hand to the rear face 3B, 4B of the deployable secondary panel 3, 4. The deployment movement described by the secondary panel 3, 4 in the reference frame of the main panel 2 is a circular translation movement. The parallelogram 9 has, at each end, hinges 10 and 12 allowing the secondary panel 3, 4 to press against the main panel 2. The point of attachment G (FIG. 2) to the secondary panel 3 is chosen so as to be close to the centre of gravity of said secondary panel so as to minimise moments of inertia during deployment.

The deployment device 5 of a secondary panel 3, 4 further comprises at least one dry-friction damper 17 (a so-called Coulomb damper). This dry-friction damper 17 is fixed, by means of auxiliary hinges 18 and 19 respectively, as depicted schematically in FIG. 2:
by a first 17A of the ends thereof to the rear face 3B of the corresponding secondary panel 3; and
by a second 17B of the ends thereof to the rear face 2B of the main panel 2.

Such a damper 17 makes it possible to achieve control of the deployment speed and damping of the end-of-travel oscillations.

The linking arms 7 and 8 of the parallelogram 9 can be produced as a honeycomb sandwich or carbon-fibre tube. Since the mechanical forces on the linking arms 7 and 8 are low, the linear density of the arms 7 and 8 is also low. In a preferred embodiment, the interfaces 20 (FIGS. 6) and 21 (FIG. 7) of the linking arms 7 and 8 with the hinges 10 and 12 are metal, made of aluminium alloy or titanium alloy.

The motorisation of the first part of the kinematics, that is to say the deployment of the secondary panel 3, 4 with the parallelogram 9, is implemented by means of springs 11 and 13 that have suitable characteristics and are prestressed so as to have sufficient energy to effect the movement. These springs 11 and 13 are released when usual stacking points of the secondary panel 3, 4 are released.

The springs 11 are fixed, for example via a part 22 in the form of projecting stud, to a structure element 23, for example of planar form, which is rigidly connected to the rear face 3B of the secondary panel 3 and substantially orthogonal to said rear face, as depicted in FIG. 6. The springs 13 are fixed to an elongate structure element 24 that is rigidly connected to the rear face 2B of the main panel 2 and is arranged transversely, as depicted in FIG. 7 and specified below with reference to FIGS. 3 to 5.

These springs 11 and 13 furthermore have the characteristics specified below.

Concerning the material used for the manufacture of the springs 11 and 13, a high modulus of resilience, satisfactory strength and good resistance to bending are sought. Thus it is possible to use a 45Si7 steel alloy (leaf spring) or the “piano wire” type spring for the springs 11 and 13. Furthermore, in order to have a Young's modulus independent of the temperature, it is possible to use Elinvar (steel with 33% nickel, 12% chromium, 1.2% manganese).

It is also possible to use for the springs 11 and 13 composite materials, based on glass fibres or carbon fibres, that have advantageous strength and mass characteristics.

Apart from the choice of the material, the performances of the springs 11 and 13 can also be improved by a surface treatment of the material. This is because the springs put the surface layers of the material under compression and traction, producing risks of fatigue failure. This treatment may for example be prestressing blasting on a metal material.

In addition, the springs 11 and 13 are preferably provided with a flexible thermal shield.

Furthermore, said hinges 10 and 12 comprise respectively resilient elements 25 (FIG. 6) and 26 (FIG. 7), for example leaf springs, which give flexibility in a plane parallel to the mid-plane of the main panel 2.

Moreover, the axes of rotation of the hinges 10 and 12 are suited to the characteristics of the segmented structure 1 so that the secondary panel 3, 4 follows the profile of the main panel 2 during rotation.

More precisely, as depicted in FIGS. 3 to 5, the longitudinal axis L of the structure element 24 (which defines the axis of rotation of the hinges 12) projects transversely at the mid-plane XZ of the main panel 2 (Z being for example defined along the axis X1-X1 and X being orthogonal to Z in this mid-plane), but is inclined with respect to the normal Y at the point in question.

More precisely, in the example depicted in these figures, the longitudinal axis L:
is offset with respect to the normal by an angle α1, for example 10° in a particular embodiment, along YZ (FIG. 4); and
is offset with respect to the normal by an angle α2, for example 5° in a particular embodiment depicted, along XY (FIG. 5).

The hinges 10 and 12 may be produced with springs of the leaf type (bending) or with cylindrical spirals (twisting) made of metal, composite or ceramic material. A deployment device 5 as described above, comprising in particular such hinges 10 and 12, has numerous advantages, and in particular:
great lightness (absence of electric motor and dedicated controls);
absence of lubrication (no pollution, resistance to low temperatures); and
good robustness to climatic conditions in a space environment (differential thermal expansion, radiation, atomic oxygen, pollution, etc.).

Moreover, said auxiliary guiding means 15, 16 intended to implement the end guidance from the position PI may be produced in various ways.

In a first embodiment, the auxiliary guiding means 15 comprise, as depicted highly schematically in FIGS. 9D and 9E:
at least one cable 28 that is connected by one of the ends thereof to the secondary panel 3 and by the other of the ends thereof to the main panel 2, at the respective contact faces 3C or 2C; and
at least one reel device 29 preferably driven by an electric motor, which is suitable for reeling said cable 28 in order to bring said secondary panel 3 towards said main panel 2.

Preferably, the auxiliary guiding means 15 comprise a plurality of associated cable 28 and reel device 29 assemblies.

This first embodiment makes it possible to effect the end guidance of the secondary panel 3, and then to fix the secondary panel 3 to the main panel 2 with the required precision and safety of operation. By means of a dynamic study, it is possible to evaluate the resonant frequencies of the cables 28 and to provide stacking points produced for example by aramid fibre cut by a hot wire. The separation between the main panel 2 and the secondary panel 3 is very small with this first embodiment, given the very small space requirement of the cables 28. The useable payload (during launch by space launcher) is therefore optimised to the maximum.

Furthermore, in a second embodiment, depicted schematically in FIG. 8, the auxiliary guiding means 16 comprise at least two guide rails 30 and 31 arranged on the rear face 2B of the main panel 2 so as to allow the secondary panel 3, 4 to slide on said guide rails 30 and 31. In the preferred embodiment depicted in FIG. 8 the auxiliary guiding means 16 comprise two guide rails 30 and 31 arranged, on either side, close to the periphery of the main panel 2. These guide rails 30 and 31 are configured so as to make it possible to guide the secondary panel 3, 4 as far as the deployed position P2. In addition, the parallelogram system 6 is configured (by a suitable arrangement of the parallelogram 9 and of the axes of rotation) so as to press said secondary panel 3, 4 on said guide rails 30 and 31 and to move it so as to implement the end guidance.

Thus, through a suitable prestressing of the springs 11 and 13, the approach end movement of the secondary panel 3, 4 on the main panel 2 is achieved. By resting on the two guide rails 30 and 31 between each secondary panel 3, 4 and the main panel 2 the expected kinematics can be produced. In addition, the friction generated by said resting could constitute a boost to the damping generated by the damper 17 or even replace it. A suitable usual fixing system (not shown) allows automatic fixing of the secondary panels 3, 4 to the main panel 2.

This second embodiment, which has motorisation incorporated in the kinematic joints, has the advantage of eliminating any motorisation and control. For the springs 11 and 13, materials are chosen having stiffness characteristics, as a function of temperature, compatible with requirements. Furthermore, flexible thermal shields can be provided to limit the temperature range experienced by the springs 11 and 13. This second embodiment is therefore simpler (no cable) and less expensive in terms of manufacture and integration. In addition, it is by design lighter (no motor, nor generation of electrical energy) and more compact.

According to the context of use, one or other of the first and second aforementioned embodiments may prove to be the more advantageous.

The devices 5 for deploying the segmented structure 1, associated with the various secondary panels 3 and 4 of this segmented structure 1, therefore make it possible to achieve deployment of the segmented structure 1 from a fully stowed position (in which the secondary panels 3 and 4 are in a storage position P1 as depicted in FIG. 9A) to a fully deployed position (in which all the secondary panels 3 and 4 are in a deployed position P2, as depicted in particular in FIG. 9F).

The deployment device 5 also comprises means that are not shown (for example a central unit) for controlling in particular the electric motor of the reel device 29.

Moreover, the segmented structure 1 comprises usual means (not shown) for holding the various panels 2, 3 and 4 in the storage position P1. These holding means are released before deployment, so that each deployment device 5 can implement the deployment specified below.

The functioning of the deployment device 5, for deploying one 3 of said secondary panels 3, 4 from the storage position P1 of FIGS. 1 and 9A to the deployed position P2 in FIG. 9E is as follows:
a) by means of the parallelogram system 6, from the storage position P1 of FIG. 9A for example, a circular translation movement of the secondary panel 3 with respect to the main panel 2 is performed, as illustrated by successive positions PA and PB in FIGS. 9B and 9C, until said intermediate position PI shown in FIG. 9D is reached; and
b) an end control (or guidance) from the intermediate position PI (FIG. 9D) to the deployed position P2 (FIG. 9E) is effected, using the auxiliary guiding means 15 or 16.

More particularly,
in the position PA in FIG. 9B, the energy in the springs is still almost maximum, and the movement is controlled by the damper 17;
in the position PB in FIG. 9C, the springs are losing their energy (as the circular translation movement progresses), and the movement is still controlled by the damper 17; and
at the end of travel, the springs no longer have any energy.

It should be noted that, once the deployment movement has been effected (step a), the docking and the end guidance of the secondary panel 3 on the main panel 2 is effected by a rotation almost perpendicular to the first rotation. Motorisation of the docking can be effected in several ways.

In the aforementioned first embodiment comprising the auxiliary guiding means 15, step b) consists of moving the secondary panel 3 towards the main panel 2 by reeling at least one cable 28 connected by one of the ends thereof to the secondary panel 3 and by the other of the ends thereof to the main panel 2, at respective contact faces 3C and 2C, by means of a reel device 29 (FIGS. 9D and 9E), until contact of the contact faces 3C and 2C is obtained (FIG. 9E).

Furthermore, in the aforementioned second embodiment comprising the auxiliary guiding means 16, step b) consists of pressing and sliding the secondary panel 3 on the guide rails 30 and 31, by means of said parallelogram system 6, as far as the deployed position P2.

The same deployment method is used for the secondary panel 4 so as ultimately to obtain a fully deployed position of the segmented structure 1, depicted in FIG. 9F.

Of course, the device 5 may also bring the segmented structure from the deployed position P2 to the storage position P1 if this were to prove necessary, for example for a validation operation, by performing the aforementioned operations in the reverse order (b, a), with each operation performed in the opposite direction.

Moreover, the segmented structure 1 may comprise means that are not shown for allowing a precise final positioning between a secondary panel 3, 4 and the main panel 2, for example in the situation in FIG. 9F, as well as means for locking the panels in the fully deployed position of the segmented structure 1.

The deployment device 5 has the advantage of simplifying the kinematic connection parts to the maximum and incorporating the deployment motorisation in the connections, without any control system. The hinges 10 and 12 do not require any particular mechanical adjustment or lubrication and do not risk seizure due to differential thermal expansion. Furthermore, dry-friction dampers 17 make it possible to control the deployment speed (in particular at the end of travel) and to prevent end-of-travel oscillation. Moreover, the use of metal, composite or ceramic materials makes it possible to guarantee an absence of degassing, and resistance to conditions in space (radiation, atomic oxygen, etc.).

1. A segmented structure, in particular for a satellite antenna reflector, said segmented structure comprising:
at least two panels, a first so-called main panel comprising a front face and a rear face, and a second so-called secondary panel also comprising a front face and a rear face; and
at least one deployment device connected to the rear faces respectively of said main and secondary panels and suitable for bringing said secondary panel into one or other of the following two positions, relative to said main panel:
a storage position, in which said secondary panel is at least partly superimposed on said main panel on the rear face of said main panel, the front face of said secondary panel being directed in the same direction as the front face of said main panel; and
a deployed position, in which said secondary panel is positioned towards the outside of the main panel, alongside and against said main panel so as to form a continuous assembly at least on the front faces thereof,
wherein said deployment device comprises:
a system with a parallelogram comprising at least two linking arms arranged substantially parallel, so as to form a parallelogram, each of said linking arms being linked by a first of the ends thereof, via a first hinge comprising at least a first spring, to the rear face of said secondary panel, and by a second of the ends thereof, via a second hinge comprising at least a second spring, to the rear face of said main panel, said first and second springs being configured, after prestressing, to move said secondary panel with respect to said main panel in a circular translation movement from the storage position to an intermediate position; and
auxiliary guiding means configured so as to implement end guidance from said intermediate position to the deployed position.

2. A segmented structure according to claim 1, wherein the deployment device also comprises at least one dry-friction damper, fixed by means of auxiliary hinges, respectively, by a first of the ends thereof to the rear face of the secondary panel and by a second of the ends thereof to the rear face of the main panel.

3. A segmented structure according to claim 1, wherein at least one of said first and second springs is made of one of the group consisting of a metal material, a composite material, and a ceramic material.

4. A segmented structure according to claim 1, wherein at least one of said first and second springs is one of a leaf spring and a torsional spring.

5. A segmented structure according to claim 1, wherein at least one of said first and second springs is provided with a surface treatment.

6. A segmented structure according to claim 1, wherein at least one of said first and second springs is provided with a flexible thermal shield.

7. A segmented structure according to claim 1, wherein at least one of said first and second hinges comprises at least one resilient element producing flexibility in a plane substantially parallel to the mid-plane of the main panel.

8. A segmented structure according to claim 1, wherein said first hinges of the linking arms of the parallelogram system are arranged substantially at the center of gravity of the secondary panel.

9. A structure according to claim 1, wherein the axes of rotation of the first and second hinges of each of the linking arms of the parallelogram system are suited to geometric characteristics of the segmented structure so that the secondary panel follows the profile of the main panel during the movement.

10. A segmented structure according to claim 1, wherein said auxiliary guiding means comprise:
at least one cable that is connected by one of the ends thereof to the secondary panel and by the other of the ends thereof to the main panel, at the respective contact faces; and
at least one reel device suitable for reeling said cable in order to bring said secondary panel towards said main panel.

11. A segmented structure according claim 1, wherein said auxiliary guiding means comprise at least two guide rails arranged on the rear face of the main panel so as to allow the secondary panel to slide on said guide rails, said guide rails being configured so as to guide the secondary panel as far as the deployed position, during the end guidance, and in that the parallelogram system is configured so as to press said secondary panel on said guide rails and to move it so as to implement the end guidance.

12. A segmented structure according to claim 1, comprising:
a middle main panel;
two secondary panels arranged on either side of said middle main panel in the deployed position so as to have a parabolic shape; and
two deployment devices associated respectively with said secondary panels.

13. A satellite antenna reflector, comprising a segmented structure according to claim 1.

14. A satellite, comprising at least one segmented structure according to claim 1.

15. A method for deploying a segmented structure according to claim 1 comprising successive steps, during deployment from the storage position to the deployed position, of:
(a) performing a circular translation movement of the secondary panel with respect to the main panel as far as said intermediate position, by means of the parallelogram system; and
(b) implementing the end guidance from the intermediate position to the deployed position, using the auxiliary guiding means.

16. A deployment method according to claim 15, wherein step (b) consists of comprises moving said secondary panel towards said main panel by reeling at least one cable connected by one of the ends thereof to the secondary panel and by the other of the ends thereof to the main panel, at respective contact faces, by means of at least one reel device.

17. A deployment method according to claim 15, wherein step (b) comprises pressing and sliding the secondary panel on at least two guide rails arranged on the rear face of the main panel, as far as the deployed position, by means of said parallelogram system.
